(19) United States
(12) Patent Application Publication
(10) Pub. No.: US 2008/0006127 A1
(43) Pub. Date: Jan. 10, 2008

(54) Tool interface device

(76) Inventor: Michael Marasco, Phoenix, AZ (US)

Correspondence Address: GARY F. WITTING, 5834 EAST OAK STREET, SCOTTSDALE, AZ, 85257, US

(21) Appl. No.: 11/482,898

(22) Filed: Jul. 7, 2006

(51) Int. Cl. B25B 13/00

(52) U.S. Cl. 81/124.2; 74/504; 81/176.15

(57) ABSTRACT

A tool interface device (100) is provided. The tool interface device (100) includes a shank (102), cylindrical body (112), top portion (124), and a tooth (232). The tooth (232) is aligned with an exterior surface (114) of cylindrical body (112). The tool interface device (100) is coupled to a rotation device (502) which imparts a rotary movement to the tool interface device (100). The coupled tool interface device (100) and the rotation device (100) are coupled to a machine table (616) of a milling machine (602).

### FIELD OF INVENTION

This invention relates in general to tool interface devices, and more particularly, to tool interface devices capable of adapting a portable rotational motion device though a tool interface device to apply a rotational force to another device.

### BACKGROUND

A large number of machines such as, but not limited to, milling machines, planing machines, and the like have an adjustable table that is raised and lowered to bring a work piece or work pieces into position so that the work piece or work pieces can be manipulated or worked on. Raising and lowering of the adjustable table is achieved by either a manual method such as a crank or a fixed automated motor driven system. Both the manual and automated systems have several deficiencies and problems.

With regard to the manual method, the manual method for raising and lowering a table for a machine is accomplished by a hand manipulated crank having an engagement end and a handle. More particularly, an operator removes the crank from a tool receptacle located in close proximity to the machine. The operator bends down or kneels down to insert the engagement end into the machine and cranks the handle, sometimes 50 to 75 revolutions or more, to raise the table to the correct height so that the machine can work on the work piece. The operator then removes the crank from the machine and puts the crank away. When work on the work piece is completed, the operator reinserts the crank into the machine and lowers the table of the machine. Depending upon the production load, this procedure of raising and lowering the table is done hundreds or thousands of times a day.

With use of these manual procedures, several problems have arisen. By way of example only, because of the constant bending or kneeling of the operator many operators suffer from repetitive injuries. Additionally, because of the tediousness of the cranking to either raise or lower the table, sometimes the operator can inadvertently raise or lower the table to much, thereby causing injury to either the operator or to the work piece. Moreover, since the cranking to raise and lower the table takes time, there is a significant loss of time and productivity. Also, it should be understood that because of the problems cited above over time, these problem can severely effect the moral of the operator.

In some cases, the machine is fitted with an automatic system such as a motor that can be switched in different directions of rotation, thereby raising and lowering the table. However, several problems exist with the automatic system. For example, the automatic system uses a large motor that extends out and away from the machine which makes the use of the machine difficult and awkward. Additionally, because of the size and location of the motor, the operator constantly runs into the motor with his legs. This continual impact can cause the operator to loose his balance and fall, bruising of the soft tissue, or the like. Moreover, the automatic system does not have a variable speed. Thus, when small distances are desired, many times the operator can push the work piece beyond the desired distance and destroy the work piece. Additionally, the automated system whether it is retrofitted or purchased with the original machine is extremely expensive, thereby putting the automated system out of financial reach of many ordinary users of these machines. Additionally, it should be noted that in some instances on some machines there is no retrofit available at all, thereby severely limiting the options of the machine.

It can be readily seen that both the manual or automatic power option tooling and methods have several problems and disadvantages which raise serious safety concerns and produces inefficiencies that increase cost and decrease quality of the product and the process. Therefore, tools, methods, and techniques that allow for more efficient and effective use of machines that require tables to be raised and lower to allow a work piece to be worked would be highly desirable.

### SUMMARY OF THE INVENTION

A tool interface device is provided. The tool interface includes a shank a first end and a second end. The shank having a length and at least one flat surface extending along at least a portion of the shank. A cylindrical body having a diameter, a central axis, a top surface, an exterior side surface, a length, a third and fourth end with the third end of the cylindrical body coupled to the second end of the shank. The top surface is located at the fourth end of the cylindrical body with a tooth disposed on the top surface of the cylindrical body. The tooth having a first surface with first, second, and third edges, a second surface with fourth, fifth, sixth, and seventh edges. The first surface is aligned with and conforms to the exterior side surface of the cylindrical body with a first distance extending from the top surface to the second edge and a second distance extending from the first edge to the third edge.

A tool interface device is shown having a shank a first end and a second end. The shank having a length and at least one flat surface extending along at least a portion of the shank. A cylindrical body having a first diameter, a central axis, a length, a top surface, an exterior side surface, an opening with a second diameter, a third and fourth end with the third end of the cylindrical body coupled to the second end of the shank. The top surface located at the fourth end of the cylindrical body with a tooth disposed on the top surface of the cylindrical body and the opening disposed about the central axis and though a portion of the cylindrical body. The tooth having a first surface with first, second, and third edges, a second surface with fourth, fifth, sixth, and seventh edges. The first surface is aligned with and conforms to the exterior side surface of the cylindrical body with a first distance extending from the top surface to the second edge and a second distance extending from the first edge to the third edge.

A method is provided for raising and lowering a machine table comprising the steps of providing a machine table having an adjustment coupling for adjusting a height of the machine table. A tool interface device is provided having a shank and a cylindrical body. The shank has at least one flat surface extending along a portion of the shank. The cylindrical body has an exterior surface and a top surface with a tooth disposed on the top surface of the cylindrical body. The tooth having a surface that is aligned with the exterior surface of the cylindrical body with the shank being mechanically coupled with the chuck of the hand drill and coupling the tooth surfaces of the tool interface device with the adjustment coupling of the machine table, wherein a rotary movement of the tool interface device moves the adjustment coupling to move the machine table.

It is an aspect of the invention to provide a tool interface device that enables a cost effective fabrication of a work piece.

It is another aspect of the invention to provide a device that enables a more cost effective method for raising and lowering of a machine table.

It is another aspect of the invention to provide additional safety in working with machines that have rotatory means for providing function.

It is another aspect of the invention to provide device and method that will lessen the propensity of adversely effecting moral of the operator.

The foregoing general description and the following detailed description are exemplary and explanatory only and are not restrictive of the invention, as defined in the appended claims.

Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 is a greatly enlarged simplified perspective illustration of a portion of a tool interface device;

FIG. 2 is a greatly enlarged simplified plan illustration of a tool interface device with a portion removed;

FIG. 3 is a greatly enlarged simplified sectional illustration taken though 3-3 of FIG. 2 of a tool interface device and plan view illustration of an opposing device with a portion of the opposing device removed;

FIG. 4 is a greatly simplified partial perspective illustration of several examples gears or teeth;

FIG. 5 is a greatly simplified illustration of a tool interface device being held by a portable rotation device;

FIG. 6 is a greatly simplified illustration of a milling machine having the tool interface device being engaged with a milling machine.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention.

Furthermore, the terms ‘first’, ‘second’, and the like herein, if any, are used inter alia for distinguishing between similar elements and not necessarily for describing a sequential or chronological order. Moreover, the terms front, back, top, bottom, over, under, and the like in the Description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF THE DRAWINGS

Before addressing details of embodiments described below, some terms are defined or clarified.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, nor” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

The term keys and ways are intended to mean a system to move two or more metal pieces across each other. Typically, keys and ways are machined pieces of metal that have cut-outs and tongues that fit into each other that are capable of moving parallel to each other. However, it should be noted that other systems can be used such as air-bearing or the like that enable moving or a sliding motion to take place.

The term coated is intended to mean any material that is deposited, spread, or placed upon another material or a chemical process that changes the surface chemistry of the other material.

The term anodized is intended to mean coating a metal with a thin protective oxide film by oxidizing the metal by some chemical process such as, but not limited to, electrolytic processes, ion implantation processes, or the like.

The term chamfered is intended to mean any suitable treatment of an edge, wherein the edge is changed to something other then a right angle or angles. For example, the edge may be beveled to any suitable angle, the edge may be rounded, or the like.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The following descriptions are of exemplary embodiments of the invention and the inventors' conceptions of the best mode and are not intended to limit the scope, applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

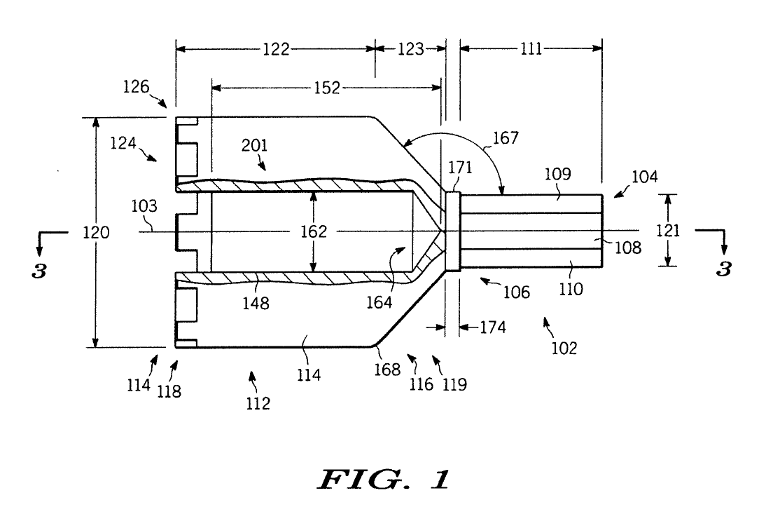

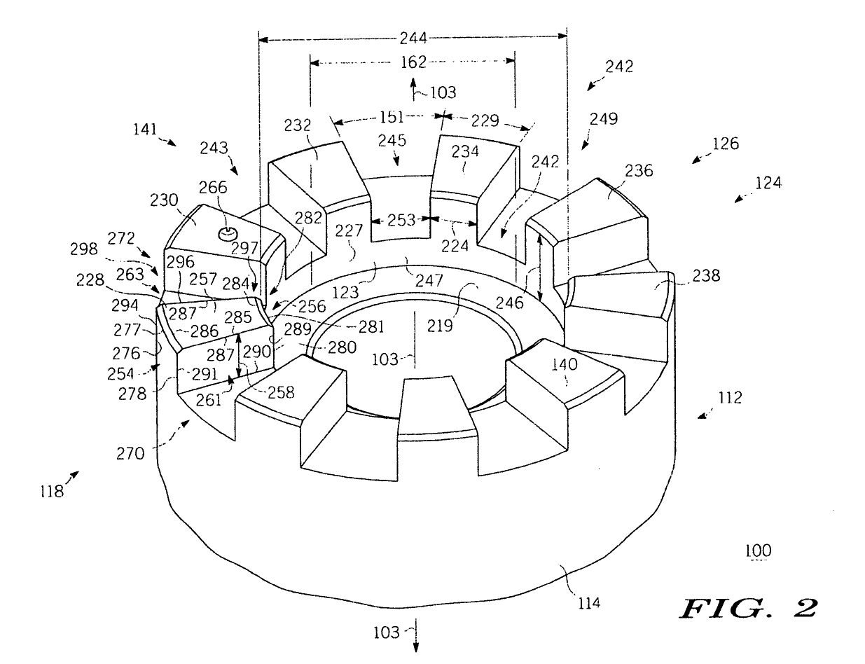

Referring now to both FIGS. 1 and 2, FIG. 1 is a greatly enlarged simplified perspective illustration of a portion of a tool interface device 100 and FIG. 2 is a greatly enlarged plan illustration of a tool interface device with a portion 201 removed to better illustrate interior features of tool interface device 100. It should be understood that similar or identical elements will retain their original identifying numbers. It should also be understood that so as to clearly illustrate the invention elements may not be drawn to scale.

Tool interface device 100 includes several elements such as a central axis 103, a shank 102, and a cylindrical body 112. Axis 103 extends though both shank 102 and cylindrical body 112. Shank 102 further includes ends 104 and 106 with flat portions 108, 109, and 110, with a length 111. Cylindrical body 112 includes an exterior surface 114, ends 116 and 118, a diameter 120, a length 122, a top surface 124, a plurality of teeth 126 including individual teeth 228-240, a plurality of spaces 141 including individual spaces 243, 245, and 249, an opening 242 having a diameter 244, a depth 246, and a surface 247, (as shown in FIG. 2) and a bore 148 having a diameter 162, a depth 152, and a bottom 164. It should be understood that bottom 164 can be made to any shape such as, but not limited to, curved to any suitable shape, ninety degree corners, or the like.

Tool interface device 100 can be made from any suitable material or any combination of materials such as, but not limited to, metals, metal alloys, organics such plastics, organo-metalic materials, ceramics, any combination of thereof, or the like. By way of example only, metals such as, but not limited to, iron (Fe) and its alloys, aluminum (Al) and its alloys, bronze, copper (Cu), brass, Titanium (Ti) and its alloys, or any combination thereof, or the like can be used to make tool interface device 100. By way of example only, in some applications, plastics such as, but not limited to, high strength thermo-plastics, polystyrenes, acrylics, and the like can be used to make tool interface device 100. More specifically and by way of example only, tool interface device 100 can be made of, but not limited to, Polyethelether (PEEK) or Polyamidimide (PAI) which is injection molded. However, it should be also understood that any suitable combination of materials, e.g., metals and plastics, that can provide enough strength can be also used.

Additionally, tool interface device 100 can be coated with any suitable material such as, but not limited to, Nickel (Ni), Chrome (Cr), or the like. Typically, the coating of tool interface device 100 and/or its various parts is achieved by any suitable method or technique such as, but not limited to electroplating, electroless plating, anodizing, black oxide, passivation, or the like. By way of example only, with tool interface device 100 being made of aluminum, the aluminum can be subsequently anodized by any well know method or technology in the art, such as, but not limited to, electrolysis or the like.

Further, it should also be understood that in some applications and depending upon the material selection, in-part or in-whole, tool interface device 100 can be magnetized.

Tool interface device 100 can be made by any suitable method or technique such as, but not limited to, milling, casting, molding, injection molding, electrical discharge machining (EDM), ablating such as laser and water ablation, and the like. It should be understood of the several methods or techniques or any of the several methods or techniques can be used either singly or in combination to make tool interface device 100.

Typically, the specific application will determine the specific material requirements and characteristics and those requirements and characteristics will determine material characteristics which in turn will determine the methods or techniques required to make interface device 100. It should be understood that it is possible that more then one technique or method can be used to make tool interface device 100 and in many instances a combination of methods or techniques are used to make tool interface device 100. By way of example only, an initial casting of tool interface device 100 can be made with a subsequent finishing process such as, but not limited to, milling, bead or sand blasting coating, or the like can be use to make a finished tool interface device 100. However, it should be noted that precision molding and casting processes can also be used which have the capability to reduce or eliminate the need for the finishing process.

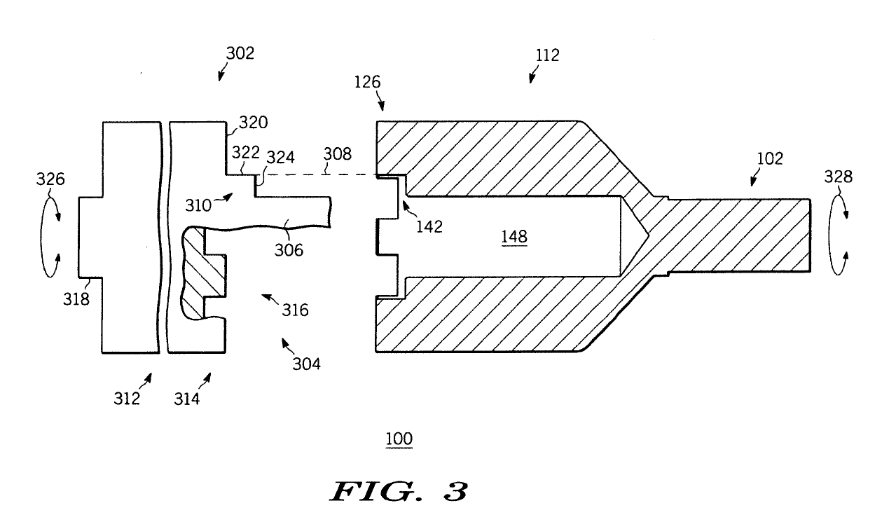

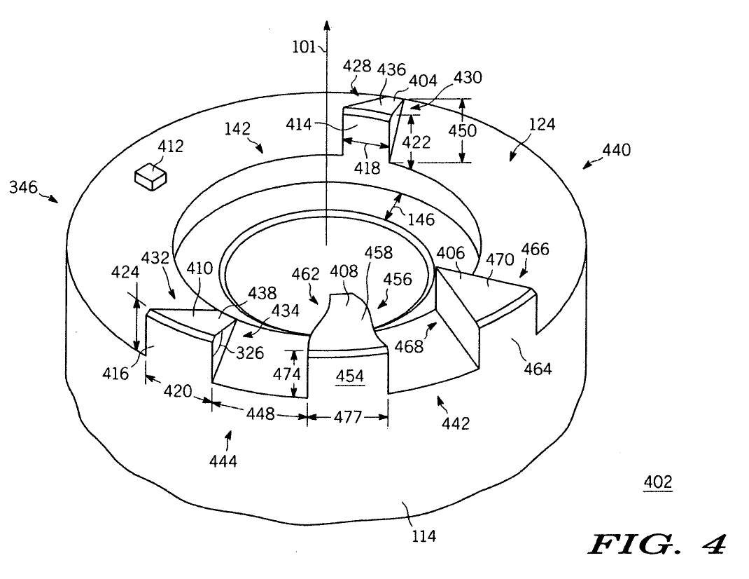

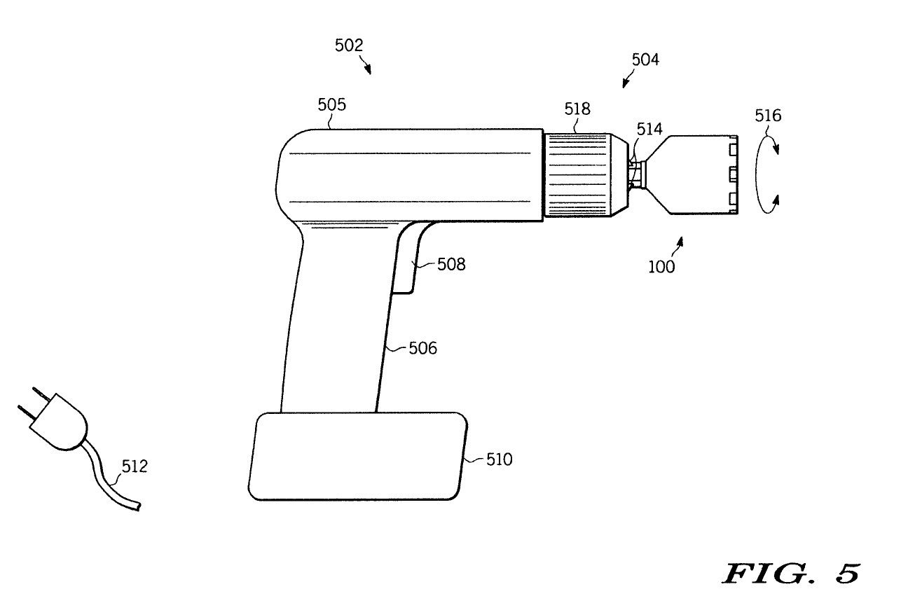

By way of example only, with shank 102 and cylindrical body 112 being made from any suitable material such as a metal or plastic material with the material being milled to the desired shape and dimensions to produce top surface 124, individual teeth such as tooth 230 or the plurality of teeth 126 can then be mounted onto or into top surface 124 by any suitable method or technique. Typically, the mounting of individual teeth or the plurality of teeth 126 and is achieved by any method or technique such as, but not limited to, a screw 266, press fitting, adhesion, or the like. By using different materials, methods, and techniques shear strengths can be adjusted so as to enable individual teeth and/or the plurality of teeth to break off with a predetermined force. By selecting different materials and or combination of materials, shapes, mounting devices and techniques, and the like, adjustment of shear strength can be adjusted to prevent damage rotational device 402, milling machine 502 and/or workpiece 526. (As shown in FIGS. 4 and 5) Additionally, top surface 124 can be made to receive a pre-manufactured plurality of teeth 126 or engagement devices, thereby enabling the exchange of one plurality of teeth 126 pattern for another different pattern. While FIGS. 1 and 2 illustrate a certain tooth pattern, other, patterns can be developed, but are not limited to, as shown in part in FIG. 3.

Moreover, it should be realized that different materials can be used to make different elements of tool interface device 100. By way of example only, the plurality of teeth 126 can be made of a different materials and attached onto or into top surface 124 so as to provide a specific material characteristic to the plurality of teeth 126 such as but not limited to, being able to shear at a specific shear strengths, coefficient of friction, or the like.

As shown in FIG. 1, shank 102 is made with a hexagonal shape with flat portions 108, 109, and 110 extending along shank 102 (In this particular illustration, three other flat portions are not shown.) However, it should be understood that other shapes and configurations are possible for shank 102. For example only, shank 102 can be shaped in a variety of configurations such as, but not limited to, round, circular, triangular, or hexagonal configuration and the like. However, by configuring shank 102 in either a hexagonal or triangular configuration, shank 102 is more tightly held by a chuck 402, as shown in FIG. 4, and is less likely to slip in chuck 402. Additionally, it should be understood that flat portions such as, but not limited to, flat portions 108, 109, and 110 can be made to have any suitable dimensions. For example and using flat portions 108, 109, and 110, flat portion 108 can be made to any suitable dimension that extends across flat portion 108 to meeting flat portions 109 and 110. These dimensions can range from 0.062 inches (1.57 mm) to 2.0 inches (50.80 mm). It should be understood that dimensions across flat portions 108, 109, and 110 depend upon diameter 121 of shank 102. Moreover, it should be further understood that measurements and dimensions can be taken from a variety of positions such as, but not limited to, measuring from one flat potion to another flat portion over end 104. By way of example only and using flat portion 108, a measurement of can be taken with a calipers by placing one jaw on flat portion 108 and placing another jaw on an opposing but parallel flat surface which is hidden from view in FIG. 1. This dimension can range from 0.062 inches (1.57 mm) to 2.0 inches (50.80 mm). It should be understood that this dimension depends upon the number flat portions and diameter 121 of shank 109.

Shank 102 can be made having any suitable length 111. Typically, length 111 can range from, but not limited to, 0.15 inches (3.81 mm) to 4.00 inches (101.60 mm) depending upon the application. Shank 102 can be made with any suitable diameter 121 such as, but not limited to, a diameter 121 ranging from 0.062 inches (1.57 mm) to 2.0 inches (50.80 mm).

End 106 of shank 102 is connected to end 116 of cylindrical body 112. Typically, cylindrical body 112 and shank 102 are made from one piece of material, thereby forming a unitary solid body. However, in some embodiments, cylindrical body 112 and shank 102 can be made separately and permanently attached together. Attachment of the shank 102 to cylindrical body 112 can be achieved by any suitable method or technique such as, but not limited to, pressing, welding, or the like.

However, in some other embodiments, cylindrical body 112 and shank 102 can be made separately and detachably affixed together, thereby enabling cylindrical body 112 with top surface 124 with a particular arrangement of the plurality of teeth 126 to be exchanged with another arrangement or pattern of the plurality of teeth. Cylindrical body 112 and shank 102 can be detachably attached by any suitable method or technique, such as, but not limited to, having cylindrical body 112 and shaft 102 being threaded into each other, locking pins, a quick release system, or the like. Thus, with shank 102 being able to be detachably affixed with different cylindrical bodies 112 having a variety of arrangements or patterns on top surface 124 (for example only, as shown in FIG. 3.), tool interface device 100 is more flexible and can be used with a variety of machines with different engagement surfaces and/or patterns.

As shown in FIG. 1, a shoulder 119 having a length 123 with an angle 167 joins end 106 of shank 102 and end 116 of cylindrical body 112 with a collar 171 therebetween. Generally, shoulder 119 is formed by diminishing diameter 120 at angle 167. Length 123 of shoulder 119 can be any suitable dimension practicable. Typically, length 123 can range from, but is not limited to, from 0.0 inches (0.0 mm) to 2.0 inches (50.80 mm), with a median range from 0.0 inches (0.0 mm) to 1.5 inches (38.10 mm), and a narrow range of 0.0 inches (0.0 mm) to 0.5 inches (12.70 mm). Also, it should be understood that in some applications, shoulder can be omitted.

Angle 167 can be made to any suitable angle that is practicable. Generally, angle 167 can range from, but is not limited to, 90 degrees to 170 degrees, with a median range of 90 degrees to 130 degrees, a narrow range from 90 degrees to 100 degrees. As can be seen in FIG. 1, as the numerical degree value of angle 167 increases a more gradual slope of shoulder 119 occurs. Also, in order to make the transition between cylindrical body 112 and shoulder 119, an arc 168 is made which smoothly transitions exterior surface 114 to shoulder 119. While any suitable arc 168 can be used, arc 168 can range from 0.0 inches (0.0 mm) to 0.25 inches (6.35 mm). When angle 167 is 90 degrees, a flat surface is produced at end 116 of cylindrical body 112 until shank 102 and/or collar 171 is formed. Shoulder 119 can also be configured with a variety of styles such as, but not limited to, stair-stepped, or the like. Also, it should be understood that shoulder 119 in certain embodiments can be effectively eliminated, thereby enabling shank 102 to be directly coupled to cylindrical body 112.

Collar 171 is placed between shoulder 119 and shank 102, wherein collar 171 has a length 174. Length 174 can be made to any suitable length such as, but not limited to, wherein length 174 can range from 0.30 inches (7.62 mm) to 0.0 inches (0.0 mm), with a median range from 0.20 inches (5.08 mm) to 0.0 inches (0.0 mm), and with a narrow range from 0.05 inches (1.27 mm) to 0.0 inches (0.0 mm). However, it should be understood that in some applications collar 171 is not necessary and may be omitted.

Cylindrical body 112 is made in the form of a cylinder having several physical dimensions such as, but not limited to length 122, diameter 120, and the like. Diameter 120 can be any suitable dimension ranging from, but not limited to, 0.25 inches (6.35 mm) to 4.0 inches (101.60 mm), with a median range from 1.0 inches (25.40 mm) to 3.0 inches (76.20 mm), and with a narrow range between 1.5 inches (38.10 mm) to 2.0 inches (50.80 mm). Length 122 can be any suitable dimension ranging from, but not limited to, 0.25 inches (6.35 mm) to 4.0 inches (101.60 mm), with a median range from 1.0 inches (25.40 mm) to 3.0 inches (76.20 mm), and with a narrow range between 1.5 inches (38.10 mm) to 2.0 inches (50.80 mm).

As shown in FIG. 3, top surface 124 can have a variety of different features incorporated into or on top of top surface 124. Any suitable feature, either singly or in a plurality, can be used such as, but not limited to, geometric designs for example only, gear teeth or cogs, square shapes, star shapes, triangular shapes, other protuberances, grooves, wedges or partial wedges, spheres or partial spheres, or the like.

By way of example only and as shown in FIG. 2, top surface 124 is formed with the plurality of teeth 126 including individual teeth 228-240 formed into top surface 124 and the plurality of spaces 141 including individual spaces 243, 245, 249, 270, and 272. In this particular embodiment, the plurality of teeth 126 are shaped as partial wedges with the plurality of spaces 141 set therebetween that are uniformly distributed around axis 103. Individual teeth 228-240 and individual spaces 243, 245, 249, 270, and 272 are used to describe and particularly point out features of the tool interface device 100.

As illustrated by tooth 228, tooth 228 is made of surfaces 254, 256, 257, 261 wherein surface 254 has edges 276-278, surface 256 has edges 280-282, surface 257 has edges 284-287, surface 261 has edges 289-292, and surface 263 has edges 294-297, with spaces 270 and 272 on either side of tooth 228. Surface 254 of tooth 228 is aligned with exterior surface 114 while surface 256 of tooth 228 opposes surface 254 and is closer to axis 103 and aligned with surface 227. Surfaces 261 and 263 having a depth 258 are opposed to each other with surfaces 261 and 263 being angled toward axis 103, thereby forming the wedge shape of tooth 228. Surface 257 is positioned on top of surfaces 254, 256, 261, and 263, wherein edge 277 of surface 254 meets edge 286 of surface 257, edge 282 of surface 256 meets edge 284 of surface 257, edge 287 of surface 261 meets edge of 285 of surface 257, and edge 296 of surface 263 meets edge 287 of surface 257. Edges 276 and 278 of surface 254 meet edge 294 of surface 263 and edge 291 of surface 261, respectively. Edges 289 and 290 of surface 261 meet edge 280 of surface 256 and edge 278 meet of surface 254, respectively. Edge 182 of surface 156 meets edge 197 of surface 163. Edges 290 and 298 meet surfaces 225 and 221, respectively. Spaces 270 and 272 are formed on either side of tooth 228 with other teeth being formed on either side of spaces 270 and 272.

Depth 258 of surfaces 261 and 263 can be any suitable dimension as is determined by the application. Typically, depth 258 ranges from 0.12 inches (3.05 mm) to 0.79 inches (20.07 mm), with a median range from 0.28 inches (7.11 mm) to 0.39 inches (9.91 mm), with a narrow range from 0.32 inches (8.13 mm) to 0.30 inches (7.62 mm). However, while depth 258 of surface 261 is shown to be uniform across the plurality of spaces 141, it should be understood that depth 258 of surface 261 can vary across the plurality of spaces 241. Further, it should be understood that depth 258 can also ungulate from space 270 to space 272 and across space 272 as shown in FIG. 1.

Dimensions for the plurality of teeth 126 and for the plurality of spaces 141 are illustrated by individual tooth 234 having widths 229 and 224 and individual space 245 having widths 251 and 253. While it should be understood that any suitable widths 229, 224, 251, and 253 can be used depending upon the application and size of tool interface device 100, several ranges are typically used. By way of example, width 224 of tooth 234 can range from, but is not limited to, a range from 0.0 inches (0.0 mm) to 1.57 inches (39.88 mm), with a median range from 0.0 inches (0.0 mm) to 1.18 inches (29.97 mm), and a narrow range from 0.0 inches (0.0 mm) to 0.51 inches (12.95 mm). Width 229 of tooth 234 can range from, but is not limited to, a range from range from 0.0 inches (0.0 mm) to 1.57 inches (39.88 mm), with a median range from 0.0 inches (0.0 mm) to 1.18 inches (29.97 mm), and a narrow range from 0.0 inches (0.0 mm) to 0.51 inches (12.95 mm). Width 251 of space 245 can range from, but is not limited to, a range from range from 0.0 inches (0.0 mm) to 1.57 inches (39.88 mm), with a median range from 0.0 inches (0.0 mm) to 1.18 inches (29.97 mm), and a narrow range from 0.0 inches (0.0 mm) to 0.51 inches (12.95 mm). Width 253 of space 245 can range from, but is not limited to, a range from range from 0.0 inches (0.0 mm) to 1.57 inches (39.88 mm), with a median range from 0.0 inches (0.0 mm) to 1.18 inches (29.97 mm), and a narrow range from 0.0 inches (0.0 mm) to 0.51 inches (12.95 mm).

Referring now to both FIGS. 1 and 2, opening 242 includes a diameter 244, surfaces 227 and 219, and depth 246 aligned and centered about axis 103. Diameter 244 defines an outer edge of opening 242 with depth 246 defining a distance from surface 219 to the top of tooth 234. As opening 242 is inset into top surface 124 of tool interface device 100, surfaces 227 and 219 is formed with corresponding depth 246. Diameter 244 of opening 242 can be made to any suitable dimensions ranging from, but not limited to, 0.0 inches (0.0 mm) to 1.57 inches (39.88 mm), with a median diameter ranging from 0.0 inches (0.0 mm) to 0.79 inches (20.07 mm), and with a narrow range from 0.0 inches (0.0 mm) to 0.20 inches (5.08 mm). Depth 246 can be made to any suitable depth that does not breach exterior surface 114. Typically, depth 246 of opening 242 can have any suitable dimensions ranging from, but not limited to, 0.0 inches (0.0 mm) to 0.79 inches (20.07 mm), with a median range being 0.0 inches (0.0 mm) to 0.39 inches (9.91 mm), and with a narrow range being 0.0 inches (0.0 mm) to 0.20 inches (5.08 mm). Depending upon the specific design, opening 242 can help guide, align, and support tool interface device 100 into opposing device 202 as shown in FIG. 3. However, while opening 242 offers certain advantages, it should be understood that in some other designs and applications, opening 242 is not necessary and does not need to be present in the present invention.

As shown in FIG. 1, bore 148 is formed having diameter 162 with a depth 152 extending from surface 247 (as shown in FIG. 2) to a bottom 164 aligned and centered about axis 103. Diameter 162 of can be any suitable size ranging from, but not limited to, 0.0 inches (0.0 mm) to 1.18 inches (29.97 mm), with median range from 0.0 inches (0.0 mm) to 0.79 inches (20.07 mm), with a narrow range from 0.0 inches (0.0 mm) to 0.08 inches (2.03 mm). Additionally, depth 152 of bore 148 can be made to any suitable dimension ranging from, but not limited to, 1.57 inches (39.88 mm) to 0.39 inches (9.91 mm), with a median range from 1.18 inches (29.97 mm) to 0.79 inches (20.07 mm), and with a narrow range from 0.98 inches (24.89 mm) to 0.20 inches (5.08 mm).

Depending upon the specific design of tool interface device 100, bore 148 can provide certain advantages such as, but not limited to, providing an alignment guide for tool interface device 100, securing tool interface device 100 to opposing device 302, providing support for tool interface device 100 (as shown in FIG. 3). However, while bore 148 offers certain advantages, it should be understood that in some other designs and applications, bore 148 is not necessary and does not need to be present in the present invention.

FIG. 3 is a greatly simplified sectional illustration taken though 3-3 of FIG. 1 of tool interface device 100 and a sectional illustration of an opposing device 302 with a portion 304 being removed from opposing device 302, wherein dotted lines 308 indicate insertion path of a shaft 306 and recessed areas 310 into bore 148 and opening 142. Opposing device 302 can be formed to include a body 312; an engagement region 314 having a plurality of teeth 316, a connecting shaft 318, the recessed areas 310 having surfaces 320, 322, and 324.

Generally, as shown in FIG. 3, engagement region 314 of opposing device 302 and the plurality of teeth 126, opening 142, and bore 148 of tool interface device 100 are meant to engage with each other so that a mechanical coupling occurs. Once a mechanical coupling occurs, a rotatory motion, illustrated by arrows 326 and 328, can be transferred though connecting shaft 318. More particularly, as shown in FIG. 3, tool interface device 100 and opposing device 302 are fitted together by sliding bore 148 over shaft, having recessed areas 310 slide into opening 142, and having engagement region 314 engage the plurality of teeth 126. Thus, as bore 148 and shaft 306 are inserted, as recess areas 310 and opening 142 are inserted, as engagement region 314 and the pluralities of teeth 316 are inserted, the engagement region 314 and the plurality of teeth 126 mesh to secure a mechanical connection. Hence, when tool interface device 100 is rotated, indicated by arrow 328, opposing device 302 also rotates, indicated by arrow 326 which then transfers the rotatory motion to connecting shaft 318 which in turn can be connected to any device that would respond to that rotational motion.

FIG. 4 is an enlarged simplified partial perspective illustration of a tool interface device 302 having several configurations of engagement devices 404-412 on or set into top surface 124 with spaces 440446 therebetween. It should be understood that engagement devices 404-412 represent only a small number of possible configurations that could be used. Additionally, it should be understood that other designs and geometries of engagement devices 404-412 and top surface 124 are fully contemplated in the present invention and that other configurations could be used. For example, top surface 124 can be formed as a curved surface; i.e., wherein a portion or portions of top surface 124 are depressed into or extend out of a normal plan of top surface 124.

As shown in FIG. 4, engagement devices 404-412 can be made to any suitable shape, geometry figure, combinations of shapes and geometric figure, either signally or in a plurality such as, but not limited to, a wedge, a star, a slit, a curved geometry, a tooth and space configuration, or the like. In all cases, the shape or geometry can be used either singly or in a plurality or in any combination thereof. These shapes or geometries can have any suitable dimensions. By way of example only, engagement device 404 and 410 are made in the shape of a slanting wedge.

By way of example only, engagement devices 404 and 410 have surfaces 414, 428, 430, 436 and 416, 432, 434, 438 respectively, wherein surfaces 414, 428, and 430 and 416, 432, and 434 form wall structures with surfaces 414 and 416 aligning with exterior surface 114 and surface 227, respectively, and wherein surfaces 436 and 438 form a top surfaces, respectively, of engagement devices 404 and 410. While FIG. 4 illustrates engagement devices 404 and 410 in a particular arrangement, it should be understood that any suitable arrangement of devices such as 404 and 410 can be used.

As shown in FIG. 4, surfaces 404 and 410 have widths 418 and 420, respectively and heights 422 and 424, respectively. Widths 418 can be made to any suitable dimension that is practicable. Generally, dimensions of widths 418 and 420 can range from 0.08 inches (2.03 mm) to 0.79 inches (20.07 mm), with a median range from 0.05 inches (1.27 mm) to 0.59 inches (14.99 mm), and with a narrow range from 0.03 inches (0.76 mm) to 0.39 inches (9.91 mm). Additionally, dimensions of heights 422 and 424 can be any suitable dimension. Generally, dimension of heights 422 and 424 can range from 0.08 inches (2.03 mm) to 0.79 inches (20.07 mm), with a median range from 0.05 inches (1.27 mm) to 0.59 inches (14.99 mm), and with a narrow range from 0.03 inches (0.76 mm) to 0.39 inches (9.91 mm).

Surfaces 436 and 438 are formed on top of surfaces 428 and 430, and 432 and 434 which form walls of engagement devices 404 and 410, respectively. As shown in FIG. 3, surfaces 436 and 438 are formed with a taper. The taper is adjusted by changing an angle 426, thereby moving surfaces 436 and 438 to the desired taper or angle. For the sake of clarity, angle 426 will only be discussed with reference to engagement device 410. Angle 426 can be set with any suitable degree or range of degrees such as, but not limited to, adjusting angle 426 within a range from 5 degrees to 90 degrees, within a median range from 15 degrees to 75 degrees, and within a narrow range from 30 degrees to 40 degrees.

It should be understood that widths 418 and 420, heights 422 and 424, and angle 426 can vary substantially depending upon the specific design. Also, it should be understood that widths 418 and 420, heights 422 and 424, and angle can vary substantially and independently from engagement device to engagement device.

As shown in FIG. 4, spaces 440-446 are formed between engagement devices 404-412. Depending upon the configuration and design of engagement devices 404-412, spaces 440-446 can have a large amount of variability. By way of example only, if there are only a few engagement device located on top surface 124, a width 448 between any two engagement devices 404-412 can be very large. However, when engagement devices 404-412 are set out as a plurality of engagement devices that are uniformly generated, then the spaces are typically regularly spaced. Typically, width 448 of spaces 440-446 can be made to any suitable dimension ranging from, but not limited to, a dimension ranging from 0.08 inches (2.03 mm) to 0.79 inches (20.07 mm), with a median dimension ranging from 0.05 inches (1.27 mm) to 0.59 inches (14.99 mm), and with a narrow dimension ranging from 0.03 inches (0.76 mm) to 0.28 inches (7.11 mm). It should be further understood that width 348 can also be random depending upon the specific design interface tool device 100.

Engagement devices 404-412 can be made to have any suitable length dimension, as illustrated by length 450 of engagement device 404. Generally, dimension of length 450 can range from 0.08 inches (2.03 mm) to 0.79 inches (20.07 mm), with a median range from 0.05 inches (1.27 mm) to 0.59 inches (14.99 mm), and with a narrow range from 0.03 inches (0.76 mm) to 0.28 (7.11 mm). It should be understood that length 450 can either extend across the entire surface of top surface 124 or any portion thereof of top surface 124.

As shown in FIG. 4, engagement device 408 is made with a serpentine shape having a surface 454 form a wall, surfaces 456 and 458 forming sidewalls, a surface 460 forming a top with at least one curve 462. Surface 454, surfaces 456 and 458, surface 460 and their associated height 474, width 477, surface 460, length and angle of taper have been previously discussed previously with reference to engagement devices 404 and 410.

Engagement device 406 is made as a curving structure having surface 464 forming a wall, surfaces 466 and 468 forming sidewalls, surface 470 forming a top with curve 472. Surface 464, surfaces 466 and 468, surface 470 and their associated height, width, surface, length and angle of taper have been previously discussed previously with reference to engagement devices 404 and 410.

Engagement device 412 is made in the shape of a cube. It should be understood that engagement device 412 can be made into any suitable geometric shape such as, but not limited to, rectangles, stars, triangle, hexagon, circles, or the like. Additionally, while only a single engagement device is shown, it should be understood that multiple geometric shapes can be placed on or into top surface 124 either in a regular or a random pattern depending upon the design requirements and/or limitations.

FIG. 5 is a greatly simplified illustration of tool interface device 100 being held by a chuck 504 of a rotational device 502. As shown in FIG. 5, rotational device 502 includes a body 505 having a motor, a pneumatic rotor, or the like (not shown), an adjustable chuck 504 with clamping jaws 514, a handle grip 506, a trigger 508, a power device 510, and a power cord 512. It should be understood that power device 510 and the attachment thereof can be any suitable power device such as a battery pack, compressed air for pneumatic tools, or the like. Also, it should be understood clamping jaws 514 of chuck 504 can be made to clamp by either a keyless or keyed system. Additionally, it should be understood that trigger 508 can be made to actuate the motor to have variable speeds. Rotational device 502 can be any suitable device that is capable of holding and providing a rotational force, illustrated by arrows 516 to tool interface device 100 which illustrates that rotational device can be made to rotate in either direction. By way of example only, rotational device 502 can be any rotational device such as, but not limited to, a manual drill, a portable drill including portable drills that are cordless and portable drills that use a power cord (as illustrated power cord 512), pneumatic tools, such as, but not limited to, pneumatic drills, or the like. It should be understood that cordless portable drills typically require a charger that supplies energy to power device 510, such as a battery pack or the like.

As shown in FIG. 5, adjustable chuck 504 includes clamping jaws 514 that move when barrel 518 is rotated in one direction to so as to clamp or tighten and in the other direction so as to un-clamp or un-tighten onto shank 102 of tool interface device 100. As shown in FIG. 5, shank 102 is made as a hexagon, thereby providing shank 102 with six flat surfaces. By having six flat surfaces, clamping jaws 514 align and clamp directly onto three of the six surfaces to provide a more secure clamping action. It should be understood that shank 102 can be made so as to accommodate the number of clamping jaws 514 in chuck 518. For example, if there are three clamping jaws 514 in chuck 504, then a three flat sided (triangular shaft) or six flat sided (hexagonal shaft) can be used, whereas if chuck 504 has four clamping jaws 514, then a four flat sided (square shaft) or the six flat sided (hexagonal shaft) can be use most effectively. However, it should be understood that in all case, a circular shaft can be used.

Once tool interface device 100 is properly secured into chuck 504 of rotational device 502, a rotational motion is transferred to tool interface device 100, indicated by arrows 516. As shown in FIG. 5, this is achieved by depressing trigger 508 which causes an electrical motor or pneumatic rotor to rotate a shaft that is connected to chuck 518 which in turn causes tool interface device 100 to also rotate as indicated by arrows 516.

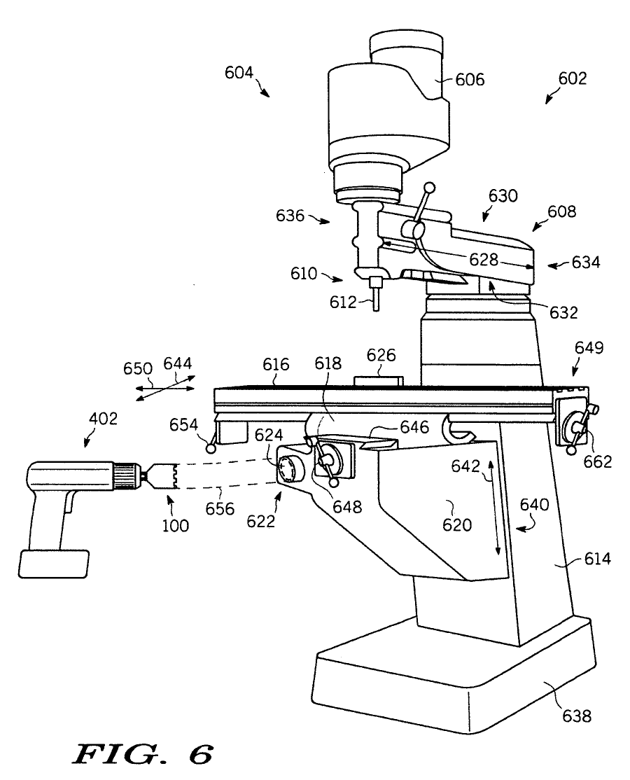

FIG. 6 is a greatly simplified illustration of a milling machine 502 having rotational device 502 with tool interface device 100 being engaged with milling machine 602. Generally, milling machine 602 includes, but not limited to, a milling head 604, a motor 606, a ram 608, a spindle 610, a milling tool 612, a column 614, a table 616, a saddle 618, a knee 620, a table height adjusting port 622, and a gear 624. Milling machines are well known in the art and only a brief description will be provided so as to more clearly and particularly point out the present invention. Additionally, it is well known that milling machines and the like are made of both cast and machined portions and it would be obvious to one of ordinary skill in the art which portions would be cast and which portion would require machining. Milling machine 602 provides an example of any suitable piece of machinery having an exposed gear 624 or opposing device 302 (as shown in FIG. 3) into which tool interface device 100 can be coupled with and wherein rotatory motion of tool interface device 100 will turn gear 624 or opposing device 202 (as shown in FIG.3). Depending upon mechanical and/or electromechanical linkages coupled to gear 624 or opposing device 302, the rotatary motion of gear 624 and opposing device 302 by tool interface device 100 is transferred to other systems that effect and provide a desired effect.

By way of example and as shown in FIG. 5, milling machine 602 is an industrial tool used for shaping and cutting a work piece 626. Typically, milling machine 602 is made of any suitable material such as, but not limited to, a metal, e.g., iron, aluminum, steel, or the like that is either cast, machined, or a combination of both. Milling machine 602 can be segmented into several main parts such as milling head 604, motor 606, ram 608, column 614, knee 618, and table 616.

Motor 606 is typically an electric motor that spins a shaft (not shown) when the electric motor is actuated by an operator. The spinning shaft provides a rotational force which is coupled to milling head 604 by any suitable means such as, but not limited to, gears, pulleys, or the like. Milling head 604 contains a transmission or any suitable substitute having variety of gears and mechanisms (not shown) that allow the rotational force that has been applied to milling head 604 to be transferred to the milling tool 612 at any desirable speed.

Generally, ram 608 is made of an elongated metal housing having a top 630, bottom 632, and ends 634 and 636. Bottom 632 of end 634 is attached to column 614. Ram 608 extends away from column 614 with a distance 628. As shown in FIG. 6, ram 608 supports and holds milling head 604 and motor 606 at end 636. As shown in FIG. 6, ram 608 is holds milling head 604 and milling tool 612 away from column 614 so that milling tool 612 is approximately over table 616. Milling head 604 is held at a distance 628 from column 614 so that distance 628 provides a working space for both large and small work pieces 626. Further, it should be understood that milling head 604, in some machines, is capable of moving milling tool 612 in a vertical fashion so as to mill work piece 626.

Generally, column 614 includes a base 638, and an adjoining system 640, that allows knee 620 to slide along a tongue and groove or key and way system, or the like in a vertical motion, as indicated by arrow 642. Typically, base 638 supplies a heavy support base that allows work piece 626 to be milled without milling machine 602 to significantly vibrate or move. As shown in FIG. 6, column 614 is positioned in the rear of base 638 so as to allow movement and use of knee 620.

Knee 620 is attached to column 614 by adjoining system 640 as previous described. Generally, knee 620 provides support to saddle 618 and table 516. In this particular example, knee 620 provides vertical motion, as indicated by arrow 642 and since saddle 618 and table 616 are supported by knee 620, when knee 620 is moved upward or downward in the vertical direction both the table 616 and saddle 618 move with knee 620.

Knee 620 can be moved in an upward and downward motion in the vertical direction, indicated by arrow 542, by a mechanical set of linkages such as, but not limited to, gears, shafts, pins, and the like. As shown in FIG. 6, milling machine 602 has port 622 wherein gear 624 is exposed. By rotating or turning gear 624, the linkage mechanism are engaged and turn an elevator screw which raises or lowers knee 620 depending upon which direction gear 624 is rotated. As shown in FIG. 6, with gear 624 being exposed though port 622; tool interface device 100 is inserted, indicated by dotted lines 656, into gear 624. Tool interface device 100 is then rotated by squeezing trigger 508 which energizes the motor in rotational device 502 which rotates chuck 504. The rotation of gear 624 by tool interface device 100 adjusts the height of table 616.

Saddle 618 is made of both cast and machined portions. Generally, saddle 618 is adjoined to knee 620 by any suitable method or technique such as, but not limited to, keys and ways, tongues and grooves, air bearings, or the like. Saddle 618 provides support for table 616 and is movable in the y direction, indicated by arrow 644. As shown in FIG. 6, saddle 618 moves along keys and ways 646 in either direction depending upon the direction crank 648 is turned.

Table 616 is made of both cast and machined portions. Generally, table 616 is adjoined to saddle 618 by any suitable method or technique such as, but not limited to keys and ways, tongue and groove, air bearings, or the like. Table 616 provides a movable flat stable support for work piece 626 so that milling tool 612 can be applied to work piece 626 so as to form work piece 626 into a desired shape. Typically, table 616 is has several t-slots, grooves 649 or the like milled into table 616 to support several accessories such as, but not limited to vices, clamps, jigs, smaller tables, and the like which can be used to hold work piece 626 so that work piece 626 can be milled. Table 616 is coupled to saddle 618 and supported by saddle 618 by any suitable method or technique. Typically, table 616 is clamped to saddle 618.

Table 616 is capable of moving in the x directions, indicated by arrow 650 by turning either crank 652 or 654 at either end of table 616, with table 616 being capable of moving in the y direction by tuning crank 648, and with table 616 being capable of moving in the z direction by turning gear 625. Thus, table 616 can be move in any desired direction (x, y, and z).

Operationally, table 616 is first lowered in the vertical direction so as to provide enough space to secure work piece 626 to table 616. Conventionally, lowering of the table is achieved by inserting a manual crank (not shown) into port 622 and manually rotating a crank (not shown) as many as 100 times to bring table 616 into a proper mounting position. Additionally, because the manual crank handle is long, the operator is hunched over when turning the manual crank which puts the operator is in an awkward position and physically strains various parts of the operator's body. The awkward position and physical strains of the operator can lead to serious injuries to the operator. Moreover, use of the manual crank is time consuming and lowers the productivity of the productivity of milling machine 506. Work piece 526 is then milled to a desired shape. After work piece 626 has been milled to the desired shape, table 616 is lowered by manually inserting the crank and rotating crank. Thus, once again putting the operator in an awkward position and physically straining the operator's body. Further, since the manually cranking table 616 takes a large amount of time, the productivity of both the machine and operator is further compromised.

However, as shown in FIG. 6, tool interface device 100 is mounted into chuck 504 of rotation device 502. Tool interface device 100 is subsequently mounted, indicated by dotted lines 627, into gear 624. Once tool interface device 100 is mounted or engaged in gear 624, trigger 508 is pulled actuating rotation device 502 to rotate tool interface device 100 and subsequently rotating gear 624 which engages linkages inside knee 620 to raise or lower knee 620 depending upon the direction of rotation of tool interface device 100. Thus, eliminating or greatly reducing the physical strain and the advent of injuries to the operator. Moreover, use of tool interface device 100 in conjunction with rotation device 502 vastly improves the productivity of milling machine 602 by semi-automating the procedure and removing the need to manually turn the crank. With the use of tool interface device 100, the raising and lowering of table 616 can be easily accomplished with one hand. Moreover, use of tool interface device 100, greatly reduces the need to hand crank work piece 626 into place, thereby reducing the amount of work and effort necessary to make work piece 626, reducing the likelihood of injury to the operator, and improving the moral of the operator who is working on work piece 626. Tool interface device 100 and rotation device 502 can either be removed or stored until further required or can be left in gear 624. It should be understood that in some cases having tool interface device 100 magnetized can add in holding tool interface device 100 to gear 624.

As can be seen, the use of tool interface device 100 can save hundreds or thousands of unnecessary repetitive motions that can affect the health of the operator, as well as increase the productivity of both the operator and milling machine 602.

### EXAMPLE

In the following specific example, tool interface device 100 is made from a cylindrical roll stock of 516 mill steel having a diameter 120 of 1.62 inches (41.15 mm). The cylindrical roll stock was cut to a length of 3.03 inches (76.96 mm). The cut cylindrical roll stock was subsequently milled into cylindrical body 112, wherein diameter 120 of cylindrical body 112 is 1.62 inches (41.15 mm) and wherein length 122 of cylindrical body 112 is 1.38 inches (35.05 mm). It should be understood that dimensions and ranges of dimensions can have a large amount of variability depending the specific application.

Shoulder 119 was then milled at end 116 of cylindrical body 112 having angle 167 being 132 degrees. Shoulder 119 is gradually reduced to a diameter of 0.56 inches (14.22 mm) with a length 1.21 inches (30.73 mm). Collar 171 was then milled by keeping the present diameter of 0.56 inches (14.22 mm) and extending that diameter for 0.10 in (2.54 mm) from shoulder 119.

The remaining material of the cylindrical roll stock is then milled into shank 102 with diameter 121 having a diameter of 0.56 inches (14.22 mm). Flat portions, e.g. 108, 109, and 110 and others, are then milled into shank 102 being made into a hexagonal shape, wherein the hexagonal shape being set as a 7/16 inch hex (0.43 inches/11.12 mm). By way of example and as shown in FIG. 1, a distance 7/16 inch hex (0.43 inches/11.12 mm) is measured from flat portion 108 to opposing flat portion on shank 104. End 104 of shank 102 was then chamfered with an indent of 0.04 inches (1.02 mm).

Top surface 124 was then milled to make the plurality of teeth 126 and the plurality of spaces 141 that are equally spaced about axis 103. Dimensions of space 145 between the plurality of teeth 126 along exterior surface 114 is 0.30 inches (7.62 mm) and can range from 0.28 inches (7.11 mm) to 0.32 inches (8.13 mm) and dimensions along surface 127 are 0.185 inches (4.70 mm) and can range from 0.17 inches (4.32 mm) to 0.20 inches (5.08 mm). Depth 158 of the plurality of spaces 141 is 0.165 inches (4.19 mm) and ranges from 0.145 inches (3.68 mm) to 0.185 inches (4.70 mm). Dimensions of the plurality of teeth 126 between the plurality of teeth 126 along exterior surface 114 is 0.30 inches (7.62 mm) and can range from 0.28 inches (7.11 mm) to 0.32 inches (8.13 mm) and dimensions along surface 127 are 0.185 inches (4.70 mm) and can range from 0.17 inches (4.32 mm) to 0.20 inches (5.08 mm). Depth 158 of spaces is 0.165 inches (4.19 mm) and ranges from 0.145 inches (3.68 mm) to 0.185 inches (4.70 mm). Individual teeth of the plurality of teeth 126, in some applications, are chamfered as shown in FIG. 2. Typically, individual teeth or the plurality of teeth 126 are chamfered with an indent of 0.04 inches (1.02 mm). However, it should be realized that the amount of chamfering is determined by the specific application and can vary greatly.

Opening 142 is milled into top surface 124 having diameter 144 of about 0.94 inches (23.88 mm) that can range from 0.74 inches (18.80 mm) to 1.14 inches (28.96 mm) with depth 146 of 0.65 inches (16.51 mm) that can range about from 0.45 inches (11.43 mm) to 0.85 inches (21.59 mm).

Bore 148 is then milled into top surface 124 of cylindrical body 112 to generate bore 148 having diameter 162. Diameter 162 is formed by milling end 116 of cylindrical body 112 to diameter 121 being 0.56 inches (14.42 mm).

Once tool interface device 100 is completely milled, tool interface device 100 is plated with nickel by any one of several standard electrodless process.

In the foregoing specification, the invention has been described with reference to specific embodiments. However, one of ordinary skill in the art appreciates that various modifications and changes can be made without departing from the scope of the invention as set fourth in the claims below. Accordingly, the specification and figures are to be regarded in an illustrative rather then a restrictive sense and all such modification are intended to be included within the scope of the invention. Benefits, another advantages, and solution to problem have been described above with regard to specific embodiments. However, the benefits, advantages, solutions to problems, and any element(s) that may cause any benefit, advantage, or solution to occur or become more pronounced are not to be construed as a critical, required or essential feature or element of any or all of the claims.

We claim:

1. A tool interface device comprising:
a shank having a first diameter with a first end and a second end, a length, and at least one flat surface on the shank, the at least one flat surface extending for at least a portion along the length of the shank;
a cylindrical body having a second diameter and a central axis, a third end and a fourth end, an exterior surface, a top surface, and a length, the top surface of the cylindrical body disposed at the fourth end and disposed about the central axis of the cylindrical body, the third end of the cylindrical body coupled to the second end of the shank; and
a first tooth having a first and a second distance on the top surface of the cylindrical body, the tooth having a first surface with a first edge, a second edge, and a third edge, a second surface with a fourth edge, a fifth edge, a sixth edge, and seventh edge, a third surface with a eighth edge, a ninth edge, a tenth edge, and a eleventh edge, wherein the first surface of the tooth is aligned and conforms with the exterior surface of the cylindrical body, wherein the fourth edge of the second surface meet the third edge of the first surface, wherein eighth edge and the ninth edge of the third surface meet with the second edge and fifth edge of the second surface, wherein the seventh edge meets with the top surface, and wherein the first distance extends from the top surface to the fifth edge of the second surface and the second distance extends from the fourth edge to the sixth edge of the second surface.

2. The tool interface device as claimed in claim 1 wherein, the first distance can range from 0.12 inches to 0.79 inches.

3. The tool interface device as claimed in claim 2 wherein, the first distance can range from 0.28 inches to 0.39 inches.

4. The tool interface device as claimed in claim 1 wherein, the second distance can range from the exterior surface to the axis.

5. The tool interface device as claim in claim 1 wherein, the coupling of the cylindrical body and the shank is accomplished by a detachable attachment method.

6. The tool interface device as claimed in claim 1 wherein, the tooth further includes a first angle at which the second surface is positioned.

7. The tool interface device as claimed in claim 6 wherein, the angle can range from 5 degrees to 89 degrees.

8. The tool interface device as claimed in claim 7 wherein, the angle can range from 15 degrees to 75 degrees.

9. The tool interface device as claimed in claim 8 wherein, the angle can range from 30 degrees to 75 degrees.

10. The tool interface device as claimed in claim 1 wherein tool interface device further includes a shoulder having a length positioned between the cylindrical body and the shank.

11. The tool interface device as claimed in claim 10 wherein, the length of the shoulder can range from 0.0 inches to 2.0 inches.

12. The tool interface device as claimed in claim 11 wherein, the length of the shoulder can range from 0.0 inches to 1.5 inches.

13. The tool interface device as claimed in claim 12 wherein the length of the shoulder can range from 0.0 inches to 0.5 inches.

14. The tool interface device as claimed in claim 1 wherein the tool interface device further includes a collar having a length positioned between the shoulder and the shank.

15. The tool interface device as claimed in claim 14 wherein, the length of the collar can range from 0.0 inches to 0.3 inches.

16. The tool interface device as claimed in claim 15 wherein, the length of the collar can range from 0.0 inches to 0.2 inches.

17. The tool interface device as claimed in claim 16 wherein, the length of the collar can range from 0.0 inches to 0.05 inches.

18. The tool interface device as claimed in claim 1 wherein, the top surface of tool interface device further includes an opening having a diameter and a depth, the opening is positioned around the axis of the cylindrical body.

19. The tool interface device as claimed in claim 18 wherein, the diameter of the opening can range from 0.0 inches to 1.57 inches.

20. The tool interface device as claimed in claim 19 wherein, the diameter of the opening can range from 0.0 inches to 0.79 inches.

21. The tool interface device as claimed in claim 20 wherein, the diameter of the opening can range from 0.0 inches to 0.20 inches.

22. The tool interface device as claimed in claim 21 wherein, the depth of the opening can range from 0.0 inches to 0.79 inches.

23. The tool interface device as claimed in claim 22 wherein, the depth of the opening can range from 0.0 inches to 0.39 inches.

24. The tool interface device as claimed in claim 22 wherein, the depth of the opening can range from 0.0 inches to 0.02 inches.

25. The tool interface device as claimed in claim 1 wherein, the top surface of tool interface device further includes a bore having a diameter and a depth, the bore is positioned around the axis of the cylindrical body.

26. The tool interface device as claimed in claim 25 wherein, the diameter of the bore can range from 0.0 inches to 1.18 inches.

27. The tool interface device as claimed in claim 26 wherein, the diameter of the bore can range from 0.0 inches to 0.79 inches.

28. The tool interface device as claimed in claim 27 wherein, the diameter of the bore can range from 0.0 inches to 0.08 inches.

29. The tool interface device as claimed in claim 25 wherein, the depth of the bore can range from 0.39 inches to 1.57 inches.

30. The tool interface device as claimed in claim 29 wherein, the depth of the bore can range from 0.79 inches to 1.18 inches.

31. The tool interface device as claimed in claim 30 wherein, the depth of the bore can range from 0.20 inches to 0.98 inches.

32. The tool interface device as claimed in claim 1 wherein, the first tooth further includes:
a fourth surface with an eleventh edge and a twelfth edge, wherein the eleventh edge and the twelfth edge of the fourth surface meet the first edge of the first surface and the eleventh edge of the third surface, respectively;
a second tooth having a first and a second distance on the top surface of the cylindrical body, the second tooth having a fifth surface with a fourteenth edge, a fifteen edge, and a sixteenth edge, a sixth surface with a seventeenth edge, an eighteenth edge, a nineteenth edge, and twentieth edge, a seventh surface with a twentieth edge, a twenty-first edge, a twenty-second edge, and a twenty-third edge, wherein the surface of the tooth is aligned and conforms with the exterior surface of the cylindrical body, wherein the fourth edge of the second surface meet the third edge of the first surface, wherein eighth edge and the ninth edge of the third surface meet with the second edge and fifth edge of the second surface, wherein the seventh edge meets with the top surface, and wherein the first distance extends from the top surface to the fifth edge of the second surface and the second distance extends from the fourth edge to the sixth edge of the second surface; and
a space with a first distance and a second distance located between the first tooth and the second tooth, wherein the first distance is between the first surface and the fifth surface of the tool interface device and the second distance is located between the sixth edge of the second surface and the nineteenth edge of the eighth surface.

33. The tool interface device as claimed in claim 32 wherein, the first distance can range from 0.01 inches to 4.0 inches and wherein the second distance can range from 0.01 inches to 4.0 inches.

34. A tool interface device comprising:
a shank having a first end and a second end, a length, and at least one flat surface on the shank, the at least one flat surface extending for at least a portion along the length of the shank;
a cylindrical body having a first diameter, a length, a central axis, a third end and a fourth end, an exterior side surface, a top surface, and an opening with a second diameter and a depth, the top surface of the cylindrical body disposed at the fourth end and disposed about the central axis of the cylindrical body, the opening disposed centrally from the top surface though a portion of the cylindrical body, and the third end of the cylindrical body coupled to the second end of the shank;
an opening having a diameter and a depth, the opening positioned around the axis of the cylindrical body;
a bore having a diameter and a depth, the bore is positioned inside the opening and around the axis of the cylindrical body;
a plurality of teeth on the top surface of the cylindrical body, the tooth having a first surface with a first edge, a second edge, and a third edge, a second surface with a fourth edge, a fifth edge, a sixth edge, and seventh edge, wherein the first surface of the tooth is aligned and conformal with the exterior side surface of the cylindrical body with a first distance extending from the top surface to the second edge of the first surface and a second distance extending from the third edge to the fourth edge and wherein the fourth edge of the second surface and the third edge of the first surface meet and are parallel to the central axis of the cylindrical body.

35. The tool interface device as claimed in claim 34 wherein the opening has a diameter that ranges from 0.0 inches to 1.57 inches.

36. The tool interface device as claimed in claim 34 wherein, the depth of the opening can range from 0.0 inches to 0.79 inches.

37. The tool interface device as claimed in claim 34 wherein, the diameter of the bore can range from 0.0 inches to 1.18 inches.

38. The tool interface device as claimed in claim 34 wherein, the depth of the bore can range from 0.39 inches to 1.57 inches.

39. The tool interface device as claimed in claim 17 wherein, at least a portion of the cylindrical body is magnetic.

40. The tool interface device as claimed in claim 34 further including a shoulder positioned between the cylindrical body and the shank.

41. The tool interface device as claimed in claim 40 further including a collar positioned between the shoulder and the shank.

42. A method for raising and lowering a machine table comprising the steps of:
providing a machine table having a gear for adjusting a height of the machine table;
providing a rotary motion device;
mounting a tool interface device to the rotary motion device, the tool interface device having a cylindrical body with a top surface having engagement devices and a shank with at least one flat surface on the shank that extends along a portion of the shank, the engagement devices having a first surface, a second surface, a third surface, a fourth surface, and a fifth surface, the first surface joined to the second and fifth surface on either side of the first surface, the fourth surface joined to the other sides second and fifth surface on either side of the first surface with the third surface joined to the first surface, second surface,
fourth surface, and the fifth surface; and coupling the engagement surface of the tool interface device with the adjustment gear of the machine table, wherein a rotatory movement of the tool interface device moves the gear to adjust the height of the machine table.

43. The method for raising and lowering a table as claimed in claim 42 wherein the step of providing a rotary motion device, the rotatory movement is achieved by a hand drill.

44. The method for raising and lowering a table as claimed in claim 42 wherein the step of providing a rotary motion device, the rotatory movement is achieved by a pneumatic device.

45. The method for raising and lower a table as claimed in claim 40, wherein the step of mounting a tool interface device, the tool cylindrical body and the shank are detachably attached together.

46. A method for raising and lowering a machine table of a milling machine comprising the steps of:
providing a milling machine having a machine table having a gear for adjusting a height of the machine table;
providing a rotary motion device;
mounting a tool interface device with the rotary motion device, the tool interface device having a cylindrical body with a top surface having engagement devices and a shank with at least one flat surface on the shank that extends along a portion of the shank; and
coupling the engagement surface of the tool interface device with the adjustment gear of the machine table, wherein a rotatory movement of the tool interface device moves the gear to adjust the height of the machine table.

47. The method for raising and lowering a machine table of a milling machine as claimed in claim 46, wherein the step of providing a rotary motion device, the rotatory movement is achieved by a hand drill.

48. The method for raising and lowering a machine table of a milling machine as claimed in claim 47, wherein the step of providing a rotatory motion device, the rotatory movement is achieved by an electric hand drill.

49. The method for raising and lowering a machine table of a milling machine as claimed 46, wherein the step of proving a rotatory motion device, the rotary movement is achieved by a pneumatic device.

50. The method for raising and lowering a table as claimed in claim 46, wherein the step of mounting a tool interface device, the tool cylindrical body and the shank are detachably attached together.
